(19) United States
(12) Patent Application Publication
(10) Pub. No.: US 2025/0192647 A1
(43) Pub. Date: Jun. 12, 2025

(54) THERMAL ENERGY TRANSFER DEVICE

(71) Applicant: GKN Aerospace Services Limited, Shirley, Solihull (GB)

(72) Inventor: Stephen Harrison, Shirley, Solihull (GB)

(21) Appl. No.: 18/845,447

(22) PCT Filed: Mar. 13, 2023
(86) PCT No.: PCT/GB2023/050588

§ 371 Date: Sep. 10, 2024

(30) Foreign Application Priority Data
Mar. 14, 2022 (GB) 2203521.6

(51) Int. Cl. H02K 9/22

(52) U.S. Cl. CPC H02K 9/223

(57) ABSTRACT

A thermal energy transfer device is provided for use in transferring thermal energy from a coil of an electrically drivable motor, the device comprising: a plurality of thermally conductive members arranged to thermally communicate with at least one coil of an electrically drivable motor; and, a thermally conductive portion connected to the plurality of thermally conductive members, wherein each of the plurality of thermally conductive members is directly electrically insulated from any other of the plurality of thermally conductive members.

### CROSS-REFERENCE TO RELATED APPLICATIONS

This application is a national stage of, and claims priority to, Patent Cooperation Treaty Application No. PCT/GB2023/050588, filed on Mar. 13, 2023, which application claims priority to Great Britain Application No. GB 2203521.6, filed on Mar. 14, 2022, which applications are hereby incorporated herein by reference in their entireties.

### BACKGROUND

Electrical propulsion systems can experience undesirable heat build up during the operation of such propulsion systems.

Electrical propulsion systems have many benefits over combustion propulsion systems, particularly in relation to chemical emissions and the like. It is widely seen that electrical propulsion systems may render transport as more viable in a long term perspective.

There are however a number of problems in the use of electrical propulsion over traditional combustion propulsion systems. In an attempt to increase the viability of electrical propulsion, attempts have been made to overcome such problems. We provide herein a further advancement in this area.

### SUMMARY

Viewed from first aspect of this disclosure there is provided a thermal energy transfer device for use in transferring thermal energy from a coil of an electrically drivable motor, the device comprising: a plurality of thermally conductive members arranged to thermally communicate with at least one coil of an electrically drivable motor; and, a thermally conductive portion connected to the plurality of thermally conductive members, wherein each of the plurality of thermally conductive members is directly electrically insulated from any other of the plurality of thermally conductive members.

Thus, thermal energy generated in an electrically drivable motor can be efficiently and effectively removed from the system without generation of currents that may give rise to additional undesirable thermal energy and a reduction in efficiency, e.g., a decrease in such energy of more than 10 times traditional systems.

In effect, a plurality of heat transmission paths are provided, each being electrically isolated from adjacent channels to prevent current build up. Decreasing additional heat generation in such a system is particularly desirable as the knock-on effects are significant. More thermal energy can be effectively transferred while simultaneously a smaller thermally conductive portion can be provided for handling the thermal energy generation from the electrically drivable motor. This provides a more compact, lightweight and therefore flight-efficient system. When arranged in an aircraft, for example, this increases the viability of electrical propulsions and therefore increases the likelihood of use over combustion engines. This in turn has a beneficial environmental impact.

In an example, the plurality of thermally conductive members are formed from the same material as a coil of an electrically drivable motor.

Such an arrangement reduces the impact of thermal expansion or contraction in the joins between the components by virtue of the common coefficient of thermal expansion of the components. Indeed, as the system relates to transferral of thermal energy prevention of varying expansions is beneficial from a structural and reliability viewpoint. The system is therefore more robust in such an arrangement and has a corresponding increased lifetime.

In an example, the plurality of thermally conductive members are elongate and have a diameter of around less than 1 mm. Advantageously, the plurality of thermally conductive members have a diameter of around 0.1 mm.

Such an arrangement further reduces the generation of undesirable currents (such as eddy currents) that may increase the amount of thermal energy generated. This thermal energy must in turn be transferred from the electrically drivable motor and so a reduction in the thermal energy generated increases efficiency. A diameter of around 0.1 mm has been found to be particularly effective in allowing for effective heat transfer, allowing for efficient insulation and simultaneously balancing against a need for manufacturing ease and tolerances. This arrangement also allows for complex geometries of thermal paths to be used and thus compact motor design to be realised.

In an example, the plurality of thermally conductive members are in the form of a plurality of adjacent strands of wire, individually insulated optionally wound around each other. Such wire arrangements are often referred to as litz wires.

Such wires are an example of elongate and narrow conductive members. Litz wires are relatively simple to produce and integrate into the system well from a manufacturing view.

In an example, the plurality of thermally conductive members are formed from high purity aluminium.

It has been found that high purity aluminium enables highly effective conducting of thermal energy. In a particular example, the purity may be around 99.99% or higher than around 99.95%.

In an example, the thermal energy transfer device further comprises a cryogen source containing a cryogen, wherein the thermally conductive portion is in thermal communication with the cryogen. The cryogen may be hydrogen, helium, nitrogen or the like, in liquid, gas, supercritical or solid phase. In an example, the cryogen may be frozen nitrogen or cryogenically frozen water.

Active cooling of the thermally conductive portion is an additional manufacturing difficulty to introduce, however it has been shown herein to be beneficial for thermal energy removal and in electrically driven aircraft propulsion, such cryogen may already be present. In essence, this arrangement takes advantage of aspects that may already be present and therefore provides improved thermal energy removal performance without the additional manufacturing or structural difficulties.

In an example, the at least a portion of the plurality of thermally conductive members is arranged into a cable, in particular a spiral or helical winding.

Such an arrangement may be particularly space efficient, easy to manufacture and robust.

In an example, the device is arranged in use so that the plurality of thermally conductive members experiences a residual eddy heating of 0.1 Watts. In an example, the device is arranged in use so that each of the plurality of thermally conductive members experiences an extremely low power of heating due to eddy currents. This creation of thermal energy, arising from the generation of eddy currents in a conductor, may be referred to herein as “eddy current heating power”. Arrangements in modern state of the art systems produce about 10 Watts of excess power that is converted into heating. In contrast, the presently disclosed arrangement produces about 0.1 Watts of excess power. This is a clear improvement.

The present disclosure provides a significant decrease in the thermal energy generation from eddy currents in the conductive elements for removing heat from the coils of an electrically drivable motor. In an arrangement, the present disclosure is able to reduce this heating by around a factor of around 100. This is a significant improvement over present systems.

In an example, each of the plurality of thermally conductive members has an outer layer of electrically insulating material. In an example this may be a resin or the like.

This prevents current passing through a thermally conductive member from forming additional unwanted currents in nearby conductive members. In particular, it is advantageous to maintain electrical isolation of the thermally conductive members from one another to prevent electrical current flowing from member to member which would generate heating. In such an example, the electrically insulating material helps to prevent direct electrical connection between the thermally conductive members. Eddy currents are generated as a by-product of the moving magnetic fields in the electrically drivable motor.

In an example, each of the plurality of thermally conductive members has an outer layer of epoxy resin. In another example, a motor coil and a heat shunt may be potted together in epoxy resin.

It has been found that epoxy resin is particularly effective and relatively straightforward from a manufacturing standpoint to provide electrical insulation. By potting a motor coil and a heat shunt in epoxy resin mechanical stability is improved as the coil becomes a self-supporting block. There is therefore improved electrical insulation provided by the epoxy resin for the electrical elements within the epoxy resin. Optionally, utilising a vacuum around elements in the device can inhibit thermal transfer from the plurality of thermally conductive members to the environment. In this way, further improvement to the retention of heat in the wires until passed to the thermally conductive portion can be provided.

Viewed from another aspect there is provided a thermal energy transfer device for use in transferring thermal energy from a coil of an electrically drivable motor, the device comprising: a plurality of thermally conductive members arranged to thermally communicate with at least one coil of an electrically drivable motor; and, a thermally conductive portion connected to the plurality of thermally conductive members, wherein a layer of insulating material is arranged between at least a portion of any adjacent pair of the plurality of thermally conductive members.

In such a device, the layer of insulating material helps prevent direct electrical communication between any two adjacent thermally conductive members.

Viewed from yet another aspect there is provided a cooling arrangement for an electrical coil winding of an electric motor, the cooling arrangement comprising: a plurality of elongate thermal conductors arranged adjacent to at least a portion of the inner and/or outer surfaces of the electrical coil winding, wherein each of said plurality of elongate thermal conductors is electrically insulated from both (a) other adjacent elongate thermal conductors and (b) the electrical coil winding.

In such an arrangement, the elongate thermal conductors are adjacent to either an inner or an outer surface of electrical coil windings, which are known to increase in temperature during use. The thermal conductors can transfer this heat from the motor coils. The insulation enables efficient removal of the thermal energy while mitigating against current transferral between adjacent conductors.

In an example, the plurality of elongate thermal conductors are arranged in close alignment and contact to the inner and/or outer surfaces of the electrical coil winding.

This improves the contact to the electrical coil winding and therefore improves conduction away of thermal energy. This also improves the arrangement against physical manipulation, in that the connection is less likely to be disrupted due to agitation or other movements or the like.

Viewed from yet another aspect there is provided an electric motor for use in an aircraft comprising: an electrical coil winding; and, a cooling arrangement according to any of the above aspects.

This arrangement provides benefits for any electrical motor. The arrangements disclosed herein however may be particularly effective for aircraft and in particular aircraft engines that utilise or hold cryogenic sources for low temperature electrical generation.

### BRIEF DESCRIPTION OF THE DRAWINGS

One or more embodiments will now be described, by way of example only, and with reference to the following figures in which:

FIG. 1 shows a schematic of a current state of the art thermal energy transfer device for use in an electrically drivable motor;

FIG. 2a shows a schematic of a thermal energy transfer device according to an example;

FIG. 2b shows a schematic of a thermal energy transfer device according to an example;

FIG. 2c shows a schematic of a thermal energy transfer device according to an example;

FIG. 3a shows a schematic of a thermal energy transfer device according to an example;

FIG. 3b shows an expanded portion of FIG. 3a; and

FIGS. 4A and 4B show schematics of a Litz wire according to an example of the present invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The disclosure is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to thermal energy conduction for use with an electrically drivable motor. A particular system for this invention may be an aircraft with a low temperature electrically drivable motor, or an electrically drivable motor utilising energy generated in low temperature environments.

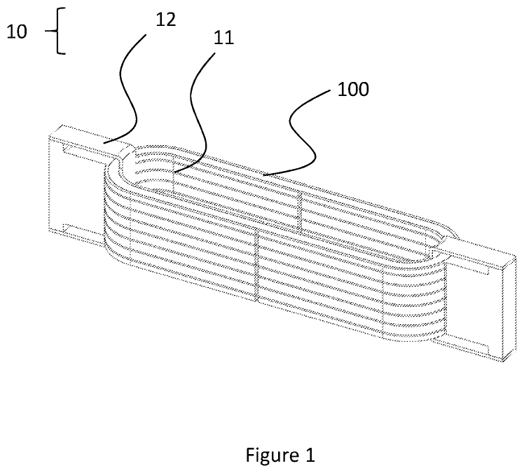

FIG. 1 shows a simple schematic of a current state of the art thermal energy transfer device 10. The current state of the art thermal energy transfer device 10 has a slotted plate 11 and a heat sink 12. The device 10 is arranged around a motor coil winding 100. The motor coil winding 100 may be operated with alternating current (AC). Such an arrangement is often used in state of the art systems.

The inventors of the system disclosed herein have recognised that eddy current suppression by the present system can be improved and that this has a significant impact on the efficiency of the overall system.

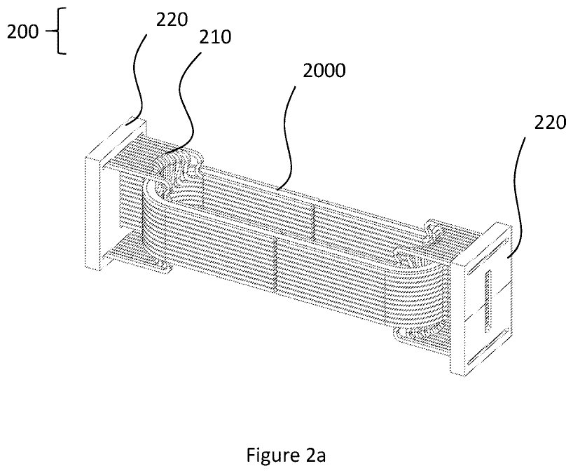

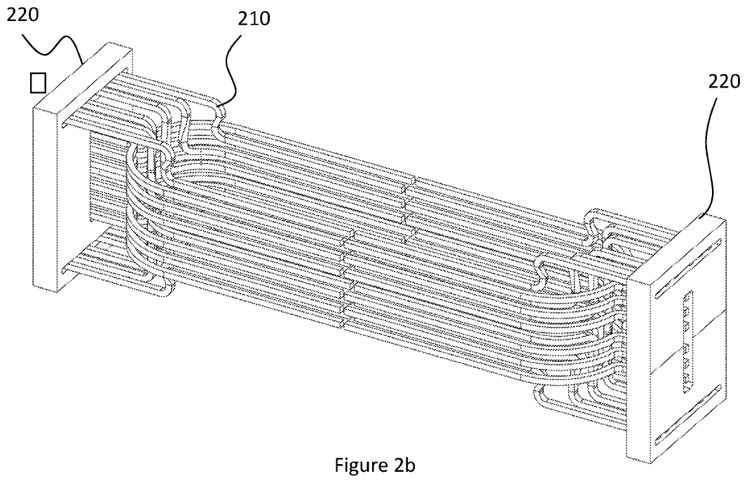

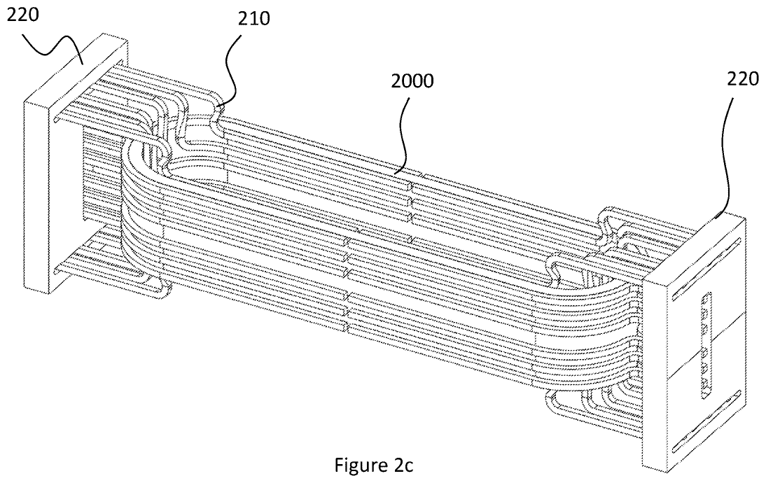

FIG. 2a shows a simple schematic of a thermal energy transfer device 200. The device 200, shown in the example of FIG. 2a, has a plurality of thermally conductive members 210 arranged to thermally communicate with at least one coil 2000 of an electrically drivable motor. The device 200 has a thermally conductive portion 220. The thermally conductive portion 220 is connected to the plurality of thermally conductive members 210. The plurality of thermally conductive members 210 are directly electrically insulated from any other of the plurality of thermally conductive members 210.

“Directly” here relates to electrical insulation between adjacent conductive members 210. The thermally conductive members 210 are connected to the thermally conductive portion 220. Therefore, a current may pass through a specific thermally conductive member through the thermally conductive portion 220 and into another thermally conductive member also connected to the thermally conductive portion 220. However, current may not pass from any one thermally conductive member 210 directly (not via a third component) to any other, or in an example any other adjacent, thermally conductive member 210.

The device disclosed herein may advantageously be used with any electrically drivable motor. In particular, the device may be used with a low temperature arrangement such as a superconducting motor arrangement or a motor with superconducting elements contained within it. Additionally, or alternatively, the device may be used with a low temperature arrangement such as a hyperconducting motor arrangement or a motor with hyperconducting elements contained within it. Each of these motor arrangements may be operated using alternating current.

The thermally conductive portion 220 may be a heat sink or the like for removing thermal energy from the thermally conductive members 210. The device 200 may have one or more thermally conductive portions 220. In the example of FIG. 2a, the device 200 has two thermally conductive portions 220 arranged at either end of the motor coil 2000. The plurality of thermally conductive members 210 may connected to both thermally conductive portions 220. The thermally conductive portion 220 may be a cold block or a large thermally conductive block that is connected to a cooling arrangement to remove thermal energy from the device 200. The thermally conductive portion 220 may have a thermal mass of around 10 times or more of the thermal mass of a thermally conductive member 210. This allows the thermally conductive portion 220 to effectively disperse thermal energy received from the thermally conductive members 210. The thermally conductive members 210 are arranged to effectively transport thermal energy while the thermally conductive portion 220 is arranged to store and disperse the thermal energy.

In an example, the plurality of thermally conductive members 210 are formed from the same material as the coil 2000 of the electrically drivable motor. In this way, when temperature changes occur, the physical connection between the elements is not warped due to thermal expansion/contraction. In particular, when conducting thermal energy away from the coil 2000, there is no physical disconnect that occurs between the elements. This ensures a more robust arrangement in use.

In an example, the plurality of thermally conductive members are elongate and have a diameter of around 0.1 mm. The diameter of a thermally conductive member may be around 1 mm, 0.9 mm, 0.8 mm, 0.7 mm, 0.6 mm, 0.5 mm, 0.4 mm, 0.3 mm, 0.2 mm, 0.1 mm or 0.05 mm. It has been found that 0.1 mm provides a balance between reducing the generation of undesirable eddy currents in the device 200 and ease of manufacturing. In a specific example, the plurality of thermally conductive members may be litz wires.

In an example, the plurality of thermally conductive members are formed from high purity aluminium. High purity aluminium may be aluminium with around a 99% purity. High purity aluminium may be aluminium with around 99.9% purity. High purity aluminium may be aluminium with around 99.99% purity. Such material typically has a residual resistivity ratio (the ratio between resistance at 273 and 4 K) of around 500. This has been found to be advantageous for use in this device.

The motor coil may be formed of other materials with similar properties such as niobium-titanium, high temperature superconductor, or magnesium diboride. Such options offer utilising superconducting properties wherein electrical resistance of effectively zero can provide extremely high electrical efficiencies. Such materials however have relatively low thermal conductivity. As such, these materials may be advantageously used in cryogenic alternating current motors for the motor coils. Such materials do not have preferential thermal energy conductivity for use in the plurality of thermally conductive members.

FIG. 2a illustrates a schematic example of a device according to the present disclosure. Element 210 may represent a plurality of thermally conductive members. The thermally conductive members may be bundled into a wire, for example a cable of wires. This may be referred to as a Litz cable. A Litz cable is a bundle of insulated strands. In an example, element 210 of FIG. 2a represents a Litz cable comprising a large number of individually electrically insulated wires. Each of these wires may be a thermally conductive member. The Litz cable may comprise between around 100 to 200 strands each of around 0.1 mm diameter. The strands need not be circular in cross section, the use of “diameter” here is illustrative for measurements. The Litz cables may or may not be individually insulated from other Litz cables. In the example shown in FIG. 2a, the Litz cable has been formed into a square cable. A Litz wire consists of multiple thin strands of wire, individually insulated from each other and bundled together. Such an arrangement advantageously hinders the production of eddy currents, when electrically conductive materials are within a moving magnetic field.

Referring now to FIGS. 2b and 2c, there are similar views to that shown in FIG. 2a. Similar features have similar reference numerals, for example FIGS. 2b and 2c show thermally conductive members 210 connecting to a thermally conductive portion 220.

In particular, FIG. 2b clearly illustrates the arrangement of the thermally conductive members 210. The motor coil has been omitted from the view shown in FIG. 2b to improve visibility of the thermally conductive members 210. Slightly fewer thermally conductive members 210 have been included in the view of FIG. 2b, again for improved visibility. In practice, the arrangement has better thermal conductivity with a greater number of thermally conductive members 210.

Referring now to FIG. 2c, a similar view to FIGS. 2a and 2b is shown. The view of FIG. 2c has a similarly “spaced” arrangement for the thermally conductive members 210, but also includes a motor coil 2000. Some thermally conductive members 210 can be seen to have a curve in their form prior to contacting the thermally conductive portion 220. This curved portion may be advantageous in accounting for thermal expansion in the arrangement during use. In particular, this formation allows for expansion and contraction during transferal of thermal energy without introducing high levels of mechanical stress into the arrangement.

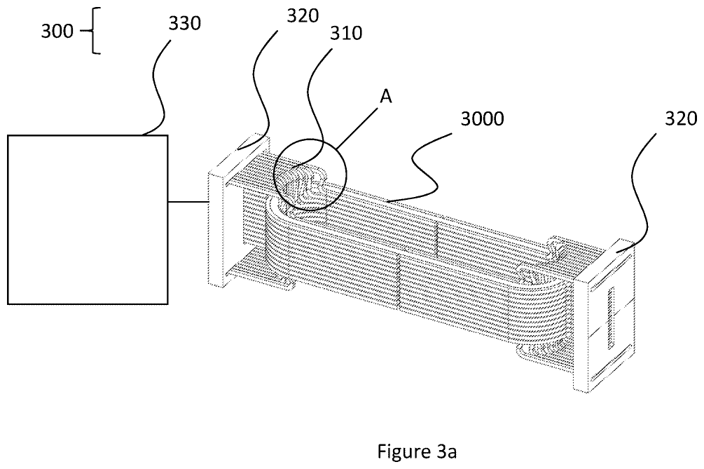

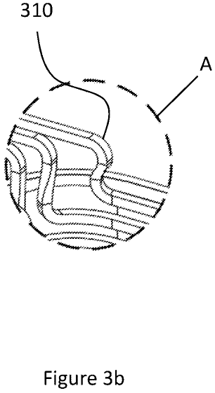

Referring now to FIG. 3a, there is shown an example of a device 300 with a coil 3000 of an electrically drivable motor. The device 300 has a plurality of thermally conductive members 310 and a thermally conductive portion 320. The device 300 also has a cryogen source 330 which contains a cryogen. The thermally conductive portion 320 is in fluid communication with the cryogen contained in the cryogen source 330.

The term “cryogen” is used to refer to the actual substance that is of a cryogenic temperature. Such a substance would in most arrangements be contained within a tank or container or the like. A cryogenic temperature clearly depends on the substance in question however cryogenic behaviour has been observed in substances up to −50° C. Therefore, cryogenic temperature is taken herein to refer to temperatures below −50° C. The cryogen may be any of hydrogen, helium, nitrogen or the like, in liquid, gas or supercritical phase. The cryogen may be helium that is cooled to a very low temperature without being liquefied. Such a cryogen is particularly suitable for use in an aircraft. In an example, the cryogen may be frozen nitrogen or cryogenically frozen water.

The thermally conductive portion 320 in the example of FIG. 3a, is actively cooled by the cryogen from the cryogen source 330. This provides a more robust removal of thermal energy and allows the device 300 to remove greater amounts of thermal energy. The active cooling of the thermally conductive portion 320 may be provided by a mechanical device such as a cryocooler or the like, which contains no cryogenic fluid other than that in a closed cycle within the cryocooler. The cooling in this example may occur by conduction.

In an example, at least a portion of the plurality of thermally conductive members 310 is arranged into a cable for example by winding. The winding may be a spiral or helical winding. Such an arrangement allows individual strands in the cable to transition from being centrally arranged in the cable to being outwardly arranged in the cable. In this way, each strand can contribute more effectively to the overall cooling of the motor coil.

In an example, the device is arranged in use so that each of the plurality of thermally conductive members 310 experiences an extremely low power of heating due to eddy currents. In comparison cables in modern state of the art systems produce about 10 Watts of excess power that is converted into heating, in the presently disclosed arrangement cables produce about 0.1 Watts of excess power. This is therefore a clear significant improvement.

Modern arrangements that have been found to provide around 10 Watts include an arrangement utilising slotted aluminium in place of the plurality of thermally conductive members or the like.

The present arrangement therefore, provides a system that can reduce undesirable heating by a factor of around 100. This improves the overall performance of the device in particular in handling the removal of thermal energy and not producing undesirable additional heating for conducting away from the device.

In an example, the plurality of thermally conductive members 310 may be bonded to the coil surfaces of the motor coil 3000. This bonding ensures strong physical connection between the elements and therefore improves thermal conductivity between the two elements. This bonding may be epoxy impregnated or the like.

In an example, each of the plurality of thermally conductive members 310 has an outer layer of electrically insulating material. Such a layer provides a barrier against generation of additional undesirable eddy currents. In a specific example, each of the plurality of thermally conductive members 310 has an outer layer of epoxy resin. The epoxy resin is an example of an electrically insulating material that is easy to produce and provides the electrical insulation desired.

Referring now to FIG. 3b, there is shown a blown-up view of portion A of FIG. 3a. FIG. 3b clearly shows a serpentine bend in a thermally conductive member 310. The bend may be a serpentine bend or a similar shape that involves curvature of the element. The bend assists in accounting for thermal expansion as explained earlier. This allows the arrangement to be more resilient against physical stress, thereby reducing the likelihood of physical damage occurring to the thermally conductive members 310 that may be delicate. In this way, the overall lifetime of the arrangement is increased. In particular, over thermal cycles materials can fatigue, which this arrangement overcomes. This results in an increased longevity and reliability for the present arrangement. Such reduced susceptibility to degradation is particularly useful in aerospace applications where safety is important.

In an example, there is a thermal energy transfer device for use in transferring thermal energy from a coil of an electrically drivable motor, the device comprising: a plurality of thermally conductive members arranged to thermally communicate with at least one coil of an electrically drivable motor; and, a thermally conductive portion connected to the plurality of thermally conductive members, wherein a layer of insulating material is arranged between at least a portion of any adjacent pair of the plurality of thermally conductive members.

In particular, the layer of insulating material is arranged between a portion of any adjacent pair so as to prevent a current passing from one thermally conductive member into an adjacent thermally conductive member. The insulating material may be along the full length of the thermally conductive member to ensure that no current can pass between adjacent thermally conductive members. In an example where one layer of electrically insulating material is used in a layered arrangement between thermally conductive members, less material is used than in an example where each thermally conductive member has a layer of electrically insulating material. Such an arrangement may therefore be cheaper to produce.

In an example, there is a cooling arrangement for an electrical coil winding of an electric motor, the cooling arrangement comprising: a plurality of elongate thermal conductors arranged adjacent to at least a portion of the inner and/or outer surfaces of the electrical coil winding, wherein each of said plurality of elongate thermal conductors is electrically insulated from both (a) other adjacent elongate thermal conductors and (b) the electrical coil winding.

While examples are disclosed herein regarding arrangements wherein the plurality of thermal conductors are adjacent a portion of the inner and/or outer surfaces of the electrical coil winding, this should not be limiting. It is advantageous for the conductors to be adjacent and secure to the electrical coil winding. This may be via the inner or outer surfaces or the conductors (or some conductors) may be arranged to connect into the body of the coil. Such a connection is also envisaged as within the scope of this disclosure. Such an arrangement fundamentally operates in the same manner to achieve the same goal; operating via the removal of thermal energy from the coil by connection to at least some of the plurality of thermal conductors.

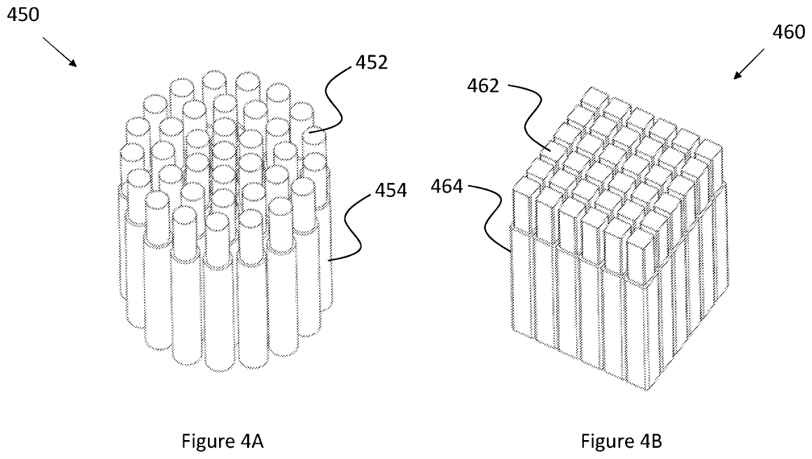

FIGS. 4A and 4B show examples of Litz wires 450, 460. Each wire 450, 460 contains a bundle of thermally conductive members 452, 462 surrounded by insulation 454, 464. The wire may be formed using a wire drawing technique. Alternatively, the wires may be printed using additive manufacturing to provide very small thickness conductive portions interlaced with insulating portions. The presently disclosed wire arrangement vastly reduces the production of eddy currents when in use. The arrangement may have a circular cross section 450 or a square cross section 460.

Further arrangements disclosed herein provide the advantages as outlined above, in particular in relation to effective thermal energy removal from the motor coil, while also reducing undesirable generation of eddy currents.

The device herein may be arranged in use as part of an electric motor. The motor may be for use in an aircraft or the like. The motor has an electrical coil winding and a cooling arrangement as described herein.

The motor may be held at low temperatures using, e.g., cryogens. The cryogen present for use with fuel cells or the like in the electrical motor may be used for cooling the thermally conductive portion in the arrangement herein. This advantageously utilises an already present feature for a secondary aspect in the device of the present disclosure.

Although the invention described herein relates to thermal energy transfer for an electric motor in particular in the example of such a motor in an aircraft, it may also be applied to application where propulsion generation involves generating undesirable heat that is to be transferred away from the point of generation.

These applications may include automotive, space, domestic or commercial propulsion generation and so forth.

The system herein is simple to manufacture, robust against physical change such as during temperature conduction, and highly effective. The system herein is an improvement over present state of the art systems.

The thermally conductive members may be manufactured via additive manufacturing to provide particularly narrow conductive elements interlaced with insulating portions.

1-23. (canceled)

24. A thermal energy transfer device for transferring thermal energy from a coil of an electrically drivable motor, the device comprising:
a plurality of thermally conductive members arranged to thermally communicate with at least one coil of an electrically drivable motor; and,
a thermally conductive portion connected to the plurality of thermally conductive members,
wherein each of the plurality of thermally conductive members is directly electrically insulated from any other of the plurality of thermally conductive members.

25. The thermal energy transfer device of claim 24, wherein the plurality of thermally conductive members are formed from a same material as a coil of an electrically drivable motor.

26. The thermal energy transfer device of claim 24, wherein the plurality of thermally conductive members are elongate and have a diameter of 0.1 mm.

27. The thermal energy transfer device of claim 24, wherein the plurality of thermally conductive members are litz wires.

28. The thermal energy transfer device of claim 24, wherein the plurality of thermally conductive members are formed from high purity aluminum.

29. The thermal energy transfer device of claim 24, further comprising a cryogen source containing a cryogen, wherein the thermally conductive portion is in thermal communication with the cryogen.

30. The thermal energy transfer device of claim 24, wherein at least a portion of the plurality of thermally conductive members is arranged into a cable.

31. The thermal energy transfer device of claim 24, arranged in use so that the plurality of thermally conductive members experiences an eddy current heating power of 0.1 Watts.

32. The thermal energy transfer device of claim 24, wherein each of the plurality of thermally conductive members has an outer layer of electrically insulating material.

33. The thermal energy transfer device of claim 24, wherein each of the plurality of thermally conductive members has an outer layer of epoxy resin.

34. A thermal energy transfer device for transferring thermal energy from a coil of an electrically drivable motor, the device comprising:
a plurality of thermally conductive members arranged to thermally communicate with at least one coil of an electrically drivable motor; and,
a thermally conductive portion connected to the plurality of thermally conductive members,
wherein a layer of insulating material is arranged between at least a portion of any adjacent pair of the plurality of thermally conductive members.

35. A cooling arrangement for an electrical coil winding of an electric motor, the cooling arrangement comprising:
a plurality of elongate thermal conductors arranged adjacent to at least a portion of the inner and/or outer surfaces of the electrical coil winding,
wherein each of said plurality of elongate thermal conductors is electrically insulated from both (a) other adjacent elongate thermal conductors and (b) the electrical coil winding.

36. The cooling arrangement of claim 35, wherein the electrical coil winding and the plurality of elongate thermal conductors are formed of a same material.

37. The cooling arrangement of claim 35, wherein the plurality of elongate thermal conductors have a diameter of 0.1 mm.

38. The cooling arrangement of claim 35, further comprising at least one heat sink connected to each of the plurality of elongate thermal conductors, wherein the heat sink is connected at ends of thermal paths of each of the plurality of elongate thermal conductors.

39. A cooling arrangement of claim 35, wherein the at least one heat sink is axially located on at least one side of the electrical coil winding.

40. The cooling arrangement of claim 35, wherein the plurality of elongate thermal conductors are in the form of wires.

41. The cooling arrangement of claim 35, wherein the plurality of elongate thermal conductors are arranged into a cable.

42. The cooling arrangement of claim 35, wherein the plurality of elongate thermal conductors are in the form of litz wires.

43. The cooling arrangement of claim 35, wherein the plurality of elongate thermal conductors are arranged in close alignment and contact to the inner and/or outer surfaces of the electrical coil winding.
